(19) United States
(12) Patent Application Publication
(10) Pub. No.: US 2022/0176657 A1
(43) Pub. Date: Jun. 9, 2022

(54) TIRE REPAIR INSERT

(71) Applicant: Jonathan Walker, Anniston, AL (US)

(72) Inventor: Jonathan Walker, Anniston, AL (US)

(21) Appl. No.: 17/114,505

(22) Filed: Dec. 8, 2020

(51) Int. Cl. B29C 73/06; B29C 73/02

(52) U.S. Cl. CPC B29C 73/066; B29C 73/02

(57) ABSTRACT

An illustrated view of an exemplary tire repair insert device for repairing a puncture of a tire is presented. The tire repair insert device is useful for repairing a simple puncture of a tire in a time and cost-efficient method. The tire repair insert device provides temporary repair until a permanent repair can be made, while preventing further damage and drivability of a vehicle. The tire repair insert device is a fast and easy process to follow and allows independence for those not physically able to replace a tire.

### FIELD OF THE INVENTION

This invention relates to tires. More particularly, it relates to devices to repair flat tires.

### BACKGROUND

A tire is a ring-shaped component that surrounds a wheel's rim to transfer a vehicle's load from the axle through the wheel to the ground and to provide traction on the surface over which the wheel travels. Most tires, such as those for automobiles and bicycles, are pneumatically inflated structures, which also provide a flexible cushion that absorbs shock as the tire rolls over rough features on the surface. Tires provide a footprint, called a contact patch, that is designed to match the weight of the vehicle with the bearing strength of the surface that it rolls over by providing a bearing pressure that will not deform the surface excessively.

The materials of modern pneumatic tires are synthetic rubber, natural rubber, fabric and wire, along with carbon black and other chemical compounds. They consist of a tread and a body. The tread provides traction while the body provides containment for a quantity of compressed air.

Everyone who has experienced a flat tire knows what an inconvenience it can be. Tires are now larger and heavier than those found on vehicles just one or two decades ago, making the tires difficult to manage for those who may be elderly, small of stature or suffer from other types of physical weakness. To address this situation, many automobile manufacturers have simply omitted spare tires and include a can of “fix-a-flat” instead. While such products may work, they require more repair work later as all traces of the canned ingredients must be removed from the tire and valve stem. Many times, a simple puncture from a nail, screw or other sharp object is the only damage and air loss is at a minimum. However, if the vehicle should be stopped just right, even at a stop light, all of the air can leak out in a manner of minutes.

Accordingly, and in light of the foregoing, there is a need for a device for temporarily repairing the tire puncture in a way to address the problems described above.

### BRIEF DESCRIPTION OF THE DRAWINGS

FIG. 1 is an illustrated view of an exemplary tire repair insert device.

FIG. 2 is an illustrated view and method of a use of the tire repair insert device shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

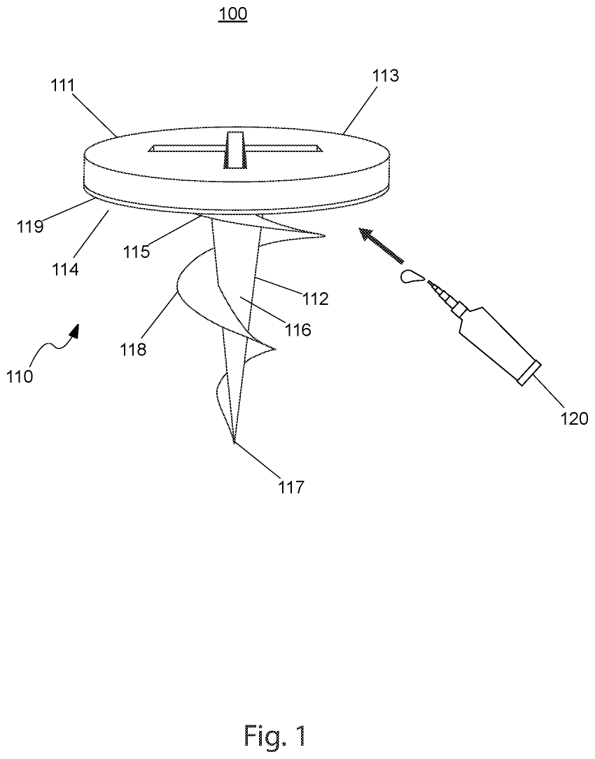

Referring to FIG. 1, an illustrated view of an exemplary tire repair insert device 100 for repairing a puncture of a tire is presented. The tire repair insert device 100 is useful for repairing a simple puncture of a tire in a time and cost-efficient method. The tire repair insert device 100 provides temporary repair until a permanent repair can be made, while preventing further damage and drivability of a vehicle. The tire repair insert device 100 is a fast and easy process to follow and allows independence for those not physically able to replace a tire.

The tire repair insert device 100 has a repair device 110 and an adhering substance 120. The repair device 110 is preferably a screw, however any other device which can be securely coupled to the tire is hereby contemplated. The adhering substance 120 is preferably tire cement, however any other substance which may adhere to the material of the tire is hereby contemplated.

The repair device 110 has a head 111 and a rod 112. The head 111 has a top portion 113 and an underside 114. The head 111 preferably has a Phillip's screwdriver coupling, however, other couplings are hereby contemplated, including, but not limited to, flat head screwdriver couplings, Allen wrench couplings, etc.

The head 111 of the repair device 110 is preferably a thickness of one-quarter inch (0.25″), however other thicknesses are hereby contemplated, including, but not limited to, one-eighth inch (⅛″), one-half inch (0.5″), etc.

The underside 114 of the head 111 preferably has a semi-pliable rubber material 119, however, other materials are hereby contemplated as would be desired by one making the repair device 110.

The rod 112 has a top 115, a body 116 and a bottom 117. The bottom 117 of the rod 112 preferably forms a point. The body 116 of the rod 112 has threads 118, the threads 118 provide a secure coupling to the tire. The threads 118 are preferably one revolution per half inch to allow a bite and a strong hold to the tire, however, other ratios of revolutions per inch are hereby contemplated by this application. The top 115 of the rod 112 are securely and permanently coupled to the underside 114 of the head 111 of the repair device 110. The rod 112 is preferably made of military grade plastic material, however other materials are hereby contemplated, including, but not limited to, steel, rubber, aluminum, etc.

The adhering substance 120 is applied to the underside 114 of the head 111 prior to the insertion of the tire repair insert device 100 into a puncture hole of the tire.

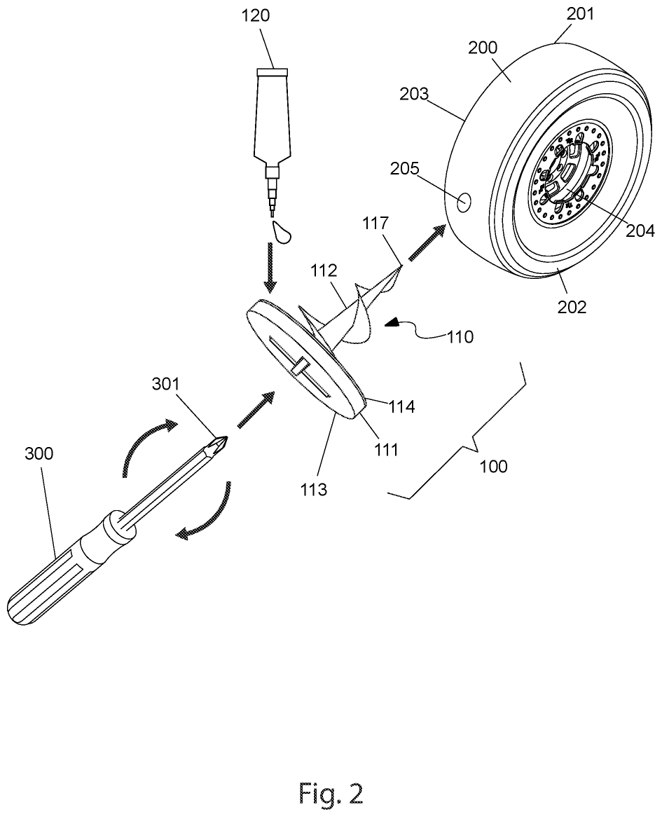

Moving now to FIG. 2, an illustrated view and method of a use of the tire repair insert device shown in FIG. 1 is presented.

A tire 200 has a tread area 201, two sidewalls 202, 203 and a wheel 204. The wheel 204 extends through the tire 200 through the sidewalls 202, 203. When the tire 200 has been punctured and is losing air, the tire 200 is inspected and a puncture hole 205 is located.

Take the repair device 110 out of a stored location and apply the adhering solution 120 to the underside 114 of the head 111 of the repair device 110.

Place the bottom 117 of the rod 112 of the repair device 100 onto the puncture hole 205 of the tire 200.

Insert a screwdriver 300, with the appropriate head end 301, onto the top 113 of the head 111 of the repair device 110.

Applying pressure to through the screwdriver 300 onto the repair device 110 and turning the screwdriver 300 in a clockwise manner to tighten the repair device 110 against the tire 200 to secure the repair device 110 to the puncture hole 205 of the tire 200.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A tire repair insert device for repairing a puncture in a tire, the device comprising:
a repair device, the repair device comprising:
a head, the head having a top, an underside and a coupling, wherein the coupling being on the top of the head, and wherein the underside of the head having semi-pliable rubber material;
a rod, the rod having a top, a body and a bottom, the top of the rod being permanently coupled to the underside of the head;
a thread, the thread being securely coupled to the body of the rod; and
an adhering substance, the adhering substance being applied to the underside of the head of the repair device.

2. The device of claim 1, wherein the head of the repair device having a thickness of one-quarter inch (0.25″).

3. The device of claim 1, wherein the coupling of the head of the repair device being a Phillip's screwdriver coupling.

4. The device of claim 1, wherein the rod being made of a military-grade plastic material.

5. The device of claim 1, wherein the threads being one-revolution per half-inch.

6. The device of claim 1, wherein the adhering solution being a tire cement.

7. A method of repairing a puncture in a tire, the method comprising:
inspecting the tire;
determining a puncture hole in the tire;
retrieving a tire repair insert device from a storage area;
applying an adhering solution to an underside of a head of a repair device of the tire repair insert device;
place a bottom of a rod of the repair device of the tire repair insert device against the puncture hole of the tire;
insert a head end of a screwdriver into a coupling of a top of the head of the repair device of the tire repair insert device; and
applying pressure to the screwdriver against the head of the repair device; and
turning the screwdriver to insert a thread of the rod of the repair device into the puncture hole of the tire until the underside of the head of the repair device is tight against the tire.

8. The method of claim 12, wherein the coupling of the head of the repair device being a Phillip's screwdriver coupling.

9. The method of claim 12, wherein the rod being made of a military-grade plastic material.

10. The method of claim 12, wherein the rod being made of a military-grade plastic material.

11. The method of claim 12, wherein the thread being one-revolution per half-inch.

12. The method of claim 12, wherein the adhering solution being a tire cement.
